(19) United States
(12) Patent Application Publication
(10) Pub. No.: US 2015/0291178 A1
(43) Pub. Date: Oct. 15, 2015

(54) APPARATUS AND METHOD FOR ESTIMATING VEHICLE VELOCITY

(71) Applicant: Hyundai Motor Company, Seoul (KR)

(72) Inventors: Seung Han You, Seoul (KR); Young Ho Shin, Seoul (KR)

(21) Appl. No.: 14/339,827

(22) Filed: Jul. 24, 2014

(30) Foreign Application Priority Data
Apr. 10, 2014 (KR) 10-2014-0043213

(51) Int. Cl. B60W 40/105; B60G 17/018

(52) U.S. Cl. CPC B60W 40/105; B60G 17/0182; B60G 2400/204; B60G 2400/41; B60G 2400/208; B60G 2600/1872; B60W 2050/0035

(57) ABSTRACT

An apparatus and a method for estimating a vehicle velocity are provided. The apparatus includes an inertia sensor that is configured to measure six degrees of freedom of a vehicle and a vehicle interior sensor that is configured to measure vehicle information. A processor is configured to estimate a kinematic model based longitudinal velocity and lateral velocity using the six degrees of freedom measured by the inertia sensor and estimate a physical model based lateral velocity and a wheel velocity based longitudinal velocity using the vehicle information. In addition, the processor is configured to estimate the vehicle velocity using the longitudinal velocity and lateral velocity.

### CROSS-REFERENCE TO RELATED APPLICATION

This application is based on and claims the benefit of priority to Korean Patent Application No. 10-2014-0043213, filed on Apr. 10, 2014 in the Korean Intellectual Property Office, the disclosure of which is incorporated herein in its entirety by reference.

### TECHNICAL FIELD

The present invention relates to an apparatus and a method for estimating a vehicle velocity, and more particularly, relates to an apparatus and method that estimate a longitudinal and lateral velocity of a vehicle in real time by utilizing an inertia sensor of six degrees of freedom.

### BACKGROUND

In general, an electronic stability program (ESP) and a vehicle motion control apparatus are configured to estimate a vehicle velocity by utilizing an inertia sensor of two degrees of freedom (e.g., lateral acceleration and yaw rate) or an inertia sensor of three degrees of freedom (e.g., longitudinal acceleration, lateral acceleration, and yaw rate). In this case, the vehicle velocity is effectively calculated in a linear tire friction interval having a substantially small longitudinal and lateral skid mainly on a plain and it may be difficult to accurately estimate the velocity in a non-linear tire friction interval having a road heeling angle present therein or a substantially large longitudinal and lateral skid.

In addition, since the vehicle velocity mainly depends on a physical model of the vehicle, it may be substantially affected by a change in vehicle parameters such as a vehicle weight, a tire, a road friction coefficient, and the like. In addition, since a technology of estimating the vehicle velocity utilizing an inertia sensor of 6 degrees of freedom according to the related art mainly estimates the vehicle velocity by integrating measurements measured by the inertia sensor of 6 degrees of freedom, it may require a high precision sensor or have a possibility of diverging estimates when being used.

### SUMMARY

The present invention provides an apparatus and a method for estimating a vehicle velocity by estimating a longitudinal and lateral velocity of a vehicle in real time by utilizing an inertia sensor of 6 degrees of freedom, a wheel velocity sensor, and a steering angle sensor. In addition, the present invention provides an apparatus and a method that may improve accuracy of vehicle velocity estimation by combining a kinematic model and a physical model using measurements measured by an inertia sensor of 6 degrees of freedom.

According to an exemplary embodiment of the present invention, an apparatus for estimating a vehicle velocity may include: an inertia sensor configured to measure 6 degrees of freedom of a vehicle; a vehicle interior sensor configured to measure vehicle information; a first longitudinal velocity and lateral velocity estimator configured to estimate a kinematic model based longitudinal velocity and lateral velocity using the 6 degrees of freedom measured by the inertia sensor; a second longitudinal velocity and lateral velocity estimator configured to estimate a physical model based lateral velocity and a wheel velocity based longitudinal velocity using the vehicle information; and a vehicle velocity estimator configured to estimate the vehicle velocity using the longitudinal velocity and lateral velocity estimates output from the first longitudinal velocity and lateral velocity estimator and the second longitudinal velocity and lateral velocity estimator.

The 6 degrees of freedom may include a longitudinal acceleration, a lateral acceleration, a vertical acceleration, a pitch rate, a yaw rate, and a roll rate. The inertia sensor may include: an acceleration sensor configured to measure the longitudinal acceleration, the lateral acceleration, and the vertical acceleration, and a gyro sensor configured to measure the pitch rate, the yaw rate, and the roll rate. The vehicle interior sensor may include: a steering angle sensor configured to measure a steering angle, and a wheel velocity sensor configured to measure a wheel velocity. The physical model may be a single track model.

The vehicle velocity estimator may include: a lateral velocity estimator configured to estimate a vehicle lateral velocity and a lateral slip angle by combining a kinematic model based lateral velocity and a physical model based lateral velocity, a longitudinal velocity estimator configured to estimate a vehicle longitudinal velocity by combining the kinematic model based longitudinal velocity and the wheel velocity based longitudinal velocity, a first weight setter configured to assign weights to the kinematic model based lateral velocity and the physical model based lateral velocity based on a driving situation, and a second weight setter configured to assign weights to a kinematic model based lateral velocity and a physical model based lateral velocity based on the driving situation.

The driving situation may be classified into a non-linear tire friction interval and a linear tire friction interval. The first weight setter may be configured to set model weights based on a rear wheel slip angle, a lateral acceleration, a yaw rate error, a steering angle change rate, an estimated divergence index, and a step steering. The second weight setter may be configured to set model weights based on a master cylinder pressure, a road friction coefficient, a pitch, a yaw rate, a lateral velocity, and a longitudinal acceleration.

According to another exemplary embodiment of the present invention, a method for estimating a vehicle velocity may include: measuring 6 degrees of freedom and vehicle information; estimating kinematic model based longitudinal velocity and lateral velocity, a physical model based lateral velocity, and a wheel velocity based longitudinal velocity using the 6 degrees of freedom and the vehicle information; and estimating the vehicle velocity by combining a longitudinal velocity and lateral velocity estimated by the kinematic model, a lateral velocity estimated using the physical model, and a longitudinal velocity estimated using the wheel velocity.

### BRIEF DESCRIPTION OF THE DRAWINGS

The above and other objects, features and advantages of the present invention will be more apparent from the following detailed description taken in conjunction with the accompanying drawings.

FIG. 1 is an exemplary block configuration diagram showing an apparatus for estimating a vehicle velocity according to an exemplary embodiment of the present invention; and

FIGS. 2 and 3 are exemplary block diagrams of a vehicle velocity estimator shown in FIG. 1 according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, exemplary embodiments of the present invention will be described with reference to the accompanying drawings.

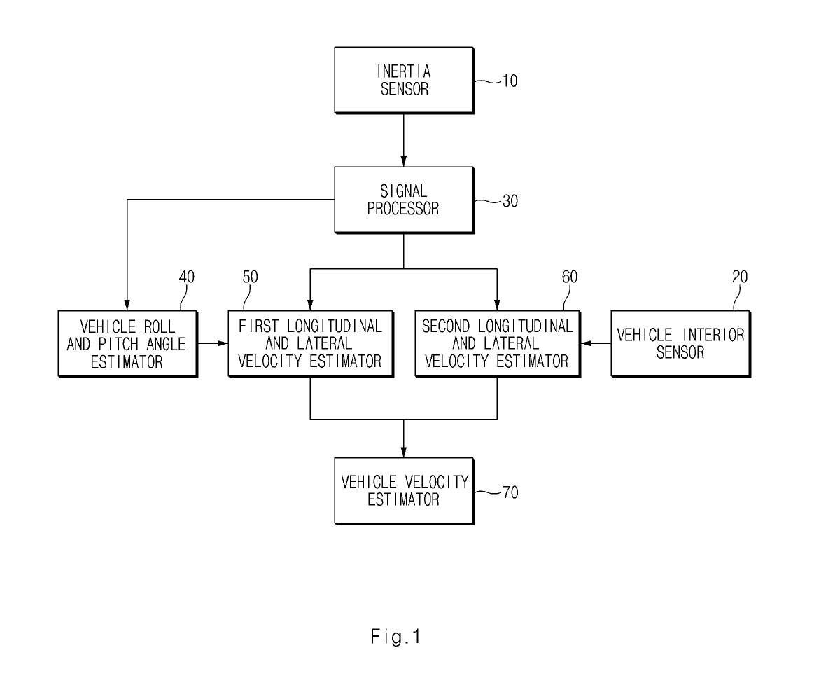

FIG. 1 is an exemplary block configuration diagram showing an apparatus for estimating a vehicle velocity according to an exemplary embodiment of the present invention. As shown in FIG. 1, an apparatus for estimating a vehicle velocity according to an exemplary embodiment of the present invention may include an inertia sensor 10, a vehicle interior sensor 20, a signal processor 30, a vehicle roll angle and pitch angle estimator 40, a first longitudinal velocity and lateral velocity estimator 50, a second longitudinal velocity and lateral velocity estimator 60, and a vehicle velocity estimator 70. The signal processor 30 may be configured to execute the vehicle roll angle and pitch angle estimator 40, the first longitudinal velocity and lateral velocity estimator 50, the second longitudinal velocity and lateral velocity estimator 60, and the vehicle velocity estimator 70.

The inertia sensor 10, which may be a sensor of 6 degrees of freedom (6DOF) for more accurately measuring a motion of a vehicle, may be configured to measure a longitudinal acceleration, a lateral acceleration, a vertical acceleration, a roll rate, a pitch rate, a yaw rate, and the like of the vehicle. The above-mentioned inertia sensor 10 may be comprised of a gyro sensor and an acceleration sensor. The vehicle interior sensor 20 may be configured to measure physical information of the vehicle (e.g., a brake pressure, a wheel velocity, and a front wheel steering angle). In addition, vehicle interior sensor 20 may include a steering angle sensor configured to measure a steering angle, a wheel velocity sensor configured to measure a wheel velocity of a 4-wheel, and the like. Particularly, the steering angle sensor may be disposed in a motor driven power steering (MDPS) system and the wheel velocity sensor may be disposed in an electronic stability control (ESC) system.

The signal processor 30 may be configured to process a raw signal output from the inertia sensor 10 to remove an offset and compensate for a misalignment error, thereby correcting the signal. The vehicle roll angle and pitch angle estimator (hereinafter, referred to as ‘a vehicle roll and pitch angle estimator’) 40 may be configured to estimate a vehicle roll angle and pitch angle based on angle information output from the gyro sensor and the acceleration sensor, a driving situation, and the like. In particular, the driving situation may be classified into a non-linear tire friction interval (dynamic) driving situation and a liner tire friction interval (static) driving situation.

The first longitudinal velocity and lateral velocity estimator (hereinafter, referred to as a first longitudinal and lateral velocity estimator’) 50 may be configured to receive information measured by the inertia sensor 10 and the roll angle and the pitch angle estimated by the vehicle roll and pitch angle estimator 40 to estimate the longitudinal velocity and the lateral velocity based on the kinematic model. The first longitudinal and lateral velocity estimator 50 may be configured to calculate the longitudinal velocity and lateral velocity by integrating a longitudinal acceleration and a lateral acceleration using an integral equation of the kinematic model.

The second longitudinal velocity and lateral velocity estimator (hereinafter, referred to as a second longitudinal and lateral velocity estimator’) 60 may be configured to calculate the lateral velocity and the longitudinal velocity using the steering angle and the wheel velocity output from the vehicle interior sensor 20. The second longitudinal and lateral velocity estimator 60 may be configured to estimate the lateral velocity using the physical model and estimate the longitudinal velocity based on the wheel velocity. In particular, as the physical model, a single track model may be used.

Furthermore, the vehicle velocity estimator 70 may be configured to assign weights to the kinematic model based longitudinal velocity and lateral velocity, the physical model based lateral velocity, and the wheel velocity based longitudinal velocity depending on the driving situation. For example, for the non-linear tire friction interval driving situation, higher weights (e.g., predetermined weights) may be assigned to the kinematic model based longitudinal velocity and lateral velocity, and for the linear tire friction interval driving situation, the weights for the physical model based lateral velocity and the wheel velocity based longitudinal velocity may be increased. The vehicle velocity estimator 70 may be configured to estimate the vehicle velocity based on the estimated longitudinal velocity and lateral velocity output from the first longitudinal and lateral estimator 50 and the second longitudinal and lateral estimator 60. In other words, the vehicle velocity estimator 70 may be configured to estimate the longitudinal velocity and the lateral velocity of the vehicle by combining the kinematic model and the physical model.

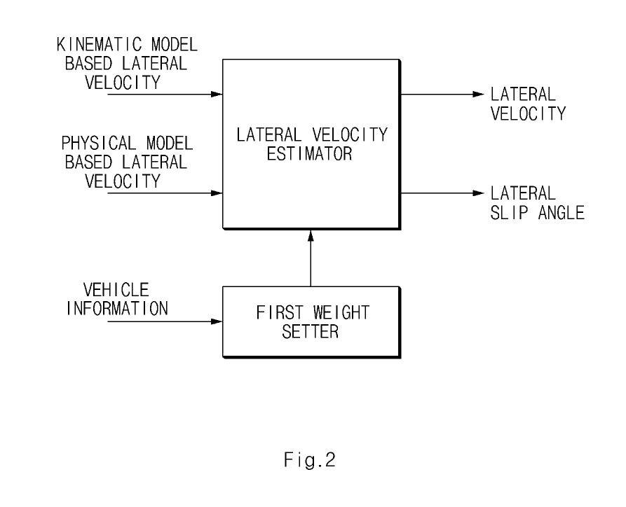

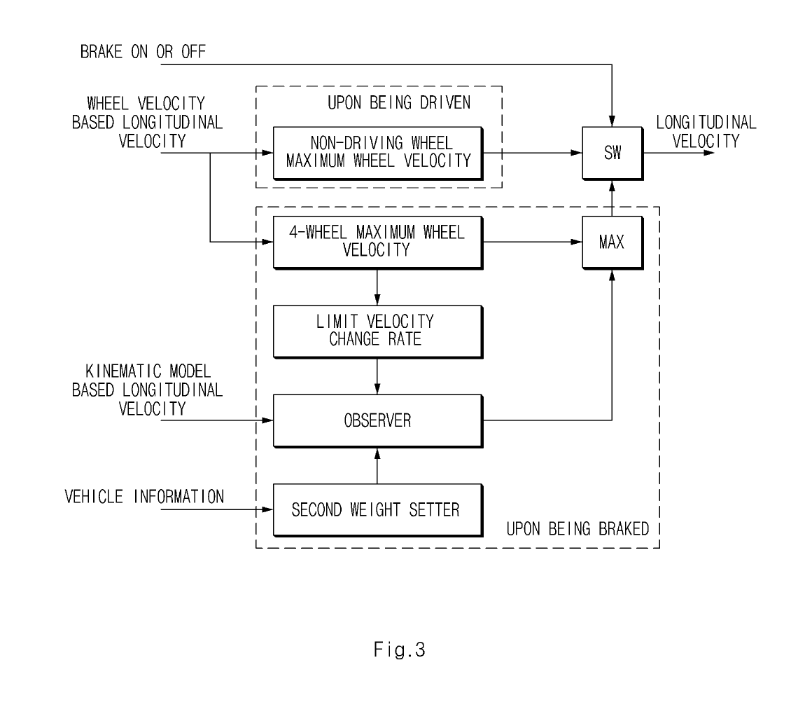

FIGS. 2 and 3 are exemplary block diagrams of a vehicle velocity estimator shown in FIG. 1. As shown in FIG. 2, a lateral velocity estimator of the vehicle velocity estimator 70 may be configured to estimate a vehicle lateral velocity and a lateral slip angle using the kinematic model based lateral velocity (e.g., an integrating value of the lateral acceleration) and the physical model based lateral velocity. In other words, the lateral velocity estimator may be configured to estimate the vehicle lateral velocity (e.g., lateral slip angle) by combining the kinematic model and the physical model.

A first weight setter may be configured to calculate a rear wheel slip angle gain (AlphaR gain), a lateral acceleration gain (Ay gain), an estimated divergence index gain (anti-drift gain), a yaw rate error gain, a steering angle slope (SAS) dot gain, and a step steering gain (J-turn gain), and set weights based on the calculated results. When the steering angle slope, the yaw rate error, the rear wheel slip angle, the lateral acceleration and the road friction coefficient are substantially large (e.g., greater than a predetermined value), the first weight setter may be configured to determine a non-linear tire friction interval and may be configured to increase the weights for the integral equation of the kinematic model. Additionally, when the estimates tend to be diverged or in a situation of the step steering, the first weight setter may be configured to increase the weights for the physical model.

Referring to FIG. 3, a longitudinal estimator of the vehicle velocity estimator 70 may be configured to receive a 4-wheel velocity and calculate a vehicle center velocity. In other words, the longitudinal estimator may be configured to calculate a wheel velocity based vehicle center velocity. The longitudinal velocity estimator may be configured to sense a brake ON and OFF based on a brake pressure (e.g., the brake being engaged or disengaged) and switch a switch SW depending on the brake ON or OFF. The longitudinal velocity estimator may be configured to calculate a non-driving wheel (e.g., rear wheel) maximum wheel velocity based on the wheel velocity based vehicle center velocity when the vehicle is being driven (e.g., the brake OFF or disengaged) and may be configured to estimate the vehicle longitudinal velocity.

Moreover, the longitudinal velocity estimator may be configured to calculate a 4-wheel maximum wheel velocity based on the wheel velocity based vehicle center velocity when the vehicle is braked (e.g., the brake ON or engaged) and may be configured to estimate a deceleration (e.g., longitudinal direction acceleration) using the kinematic model. In particular, the longitudinal velocity estimator may be configured to limit a velocity change rate. An observer integrates the longitudinal acceleration to calculate the longitudinal velocity and estimates the vehicle longitudinal velocity by combining with the wheel velocity based longitudinal velocity. Particularly, a second weight setter may be configured to determine weights using a pitch, the yaw rate, the lateral velocity, the longitudinal acceleration, the road friction coefficient, a master cylinder pressure, and the like. For example, as the master cylinder pressure (e.g., driver brake pressure) increases and the road friction coefficient decreases, the second weight setter may be configured to increase the weights for the integral equation of the kinematic model.

The longitudinal estimator may be configured to output a substantially large value (e.g., greater than a predetermined value) among the 4-wheel maximum wheel velocity and the longitudinal estimate output from the observer, as the vehicle longitudinal velocity. The vehicle velocity estimator 70 may be configured to estimate the longitudinal velocity {circumflex over (\dot{v}ₓ, the lateral velocity {circumflex over (\dot{v}_{y}, and a vertical velocity {circumflex over (\dot{v}_{z} using the following Equation 1.

$$[ \begin{matrix}{\dot{\hat{v}}}_{x} \\ {\dot{\hat{v}}}_{y} \\ {\dot{\hat{v}}}_{z}\end{matrix} ] = [ \begin{matrix}0 & {ω}_{z} & - {ω}_{y} \\ - {ω}_{z} & - {k}_{4} & {ω}_{x} \\ {ω}_{y} & - {ω}_{x} & - {k}_{5}\end{matrix} ] [ \begin{matrix}{\hat{v}}_{x} \\ {\hat{v}}_{y} \\ {\hat{v}}_{z}\end{matrix} ] + [ \begin{matrix}{a}_{x} \\ {a}_{y} \\ {a}_{z}\end{matrix} ] - g [ \begin{matrix}- sin \hat{θ} \\ sin \hat{φ} cos \hat{θ} \\ cos \hat{φ} cos \hat{θ}\end{matrix} ] + {L}_{3 \times 2} [ \begin{matrix}{v}_{x , wheel} - {\hat{v}}_{x} \\ {v}_{y , phy} - {\hat{v}}_{y}\end{matrix} ] \qquad Equation 1$$

wherein \hat{v}ₓ, \hat{v}_{y}, and \hat{v}_{z} are referred to as the longitudinal velocity, the lateral velocity, and the vertical velocity based on the kinematic model, respectively, aₓ, a_{y}, and a_{z} are the longitudinal acceleration, the lateral acceleration, and a vertical acceleration, respectively, g is an acceleration of gravity, \hat{θ} and \hat{φ} are the pitch angle and the roll angle, respectively. v_{x,wheel} is the longitudinal velocity estimated based on the wheel velocity and v_{y,phy} is the lateral velocity estimated based on the physical model. L_{3×2} is referred to as a model weight setting gain. ωₓ, ω_{y}, and ω_{z} are referred to as a roll rate error, a pitch rate error, and a yaw rate error, respectively. k₄ and k₅ are referred to as tire stiffness coefficients.

As described above, according to the exemplary embodiments of the present invention, the longitudinal and lateral velocity of the vehicle may be measured in real time utilizing the inertia sensor of 6 degrees of freedom, the wheel velocity sensor, and the steering angle sensor. In addition, according to the exemplary embodiment of the present invention, the disturbance caused by the roll angle and the pitch angle of the vehicle, and the longitudinal inclined angle and the lateral inclined angle of the road may be compensated, and the estimation performance resistant to fluctuation in the weight of the vehicle, the fluctuation in the tire state, and the fluctuation in the road friction coefficient may be provided.

In addition, according to the exemplary embodiment of the present invention, when the kinematic model based on the inertia sensor of 6 degrees of freedom and the physical model are combined, the weight value between the respective models may be changed based on the driving situation, thereby making it possible to improve the accuracy of the vehicle velocity estimation. Therefore, according to the exemplary embodiment of the present invention, by utilizing the lateral velocity of the vehicle estimated by the electronic stability control, a stability control intervention timing may be more accurately captured and a more precise control amount may be calculated. Further, according to the exemplary embodiment of the present invention, by utilizing the lateral velocity of the vehicle estimated by a chassis integrated control system, a tire slip angle may be more accurately estimated and a more precise front and rear active steering angle may be controlled.

What is claimed is:

1. An apparatus for estimating a vehicle velocity, the apparatus comprising:
an inertia sensor configured to measure six degrees of freedom of a vehicle;
a vehicle interior sensor configured to measure vehicle information;
a processor configured to:
estimate a kinematic model based longitudinal velocity and lateral velocity using the 6 degrees of freedom measured by the inertia sensor;
estimate a physical model based lateral velocity and a wheel velocity based longitudinal velocity using the vehicle information;
estimate the vehicle velocity using the longitudinal velocity and lateral velocity.

2. The apparatus according to claim 1, wherein the six degrees of freedom includes a longitudinal acceleration, a lateral acceleration, a vertical acceleration, a pitch rate, a yaw rate, and a roll rate.

3. The apparatus according to claim 1, wherein the inertia sensor includes:
an acceleration sensor configured to measure the longitudinal acceleration, the lateral acceleration, and the vertical acceleration, and
a gyro sensor configured to measure the pitch rate, the yaw rate, and the roll rate.

4. The apparatus according to claim 1, wherein the vehicle interior sensor includes:
a steering angle sensor configured to measure a steering angle, and
a wheel velocity sensor configured to measure a wheel velocity.

5. The apparatus according to claim 1, wherein the physical model is a single track model.

6. The apparatus according to claim 1, wherein the processor is further configured to:
estimate a vehicle lateral velocity and a lateral slip angle by combining a kinematic model based lateral velocity and a physical model based lateral velocity,
estimate a vehicle longitudinal velocity by combining the kinematic model based longitudinal velocity and the wheel velocity based longitudinal velocity,
assign weights to the kinematic model based lateral velocity and the physical model based lateral velocity depending on a driving situation, and
assign weights to a kinematic model based lateral velocity and a physical model based lateral velocity depending on the driving situation.

7. The apparatus according to claim 6, wherein the driving situation is classified into a non-linear tire friction interval and a linear tire friction interval.

8. The apparatus according to claim 6, wherein the processor is configured to set model weights based on a rear wheel slip angle, a lateral acceleration, a yaw rate error, a steering angle change rate, and an estimated divergence index.

9. The apparatus according to claim 6, wherein the processor is configured to set model weights based on a master cylinder pressure, a road friction coefficient, a pitch, a yaw rate, a lateral velocity, and a longitudinal acceleration.

10. A method for estimating a vehicle velocity, the method comprising:
measuring, by a sensor, six degrees of freedom and vehicle information;
estimating, by a processor, kinematic model based longitudinal velocity and lateral velocity, a physical model based lateral velocity, and a wheel velocity based longitudinal velocity using the six degrees of freedom and the vehicle information; and
estimating, by the processor, the vehicle velocity by combining a longitudinal velocity and lateral velocity estimated by the kinematic model, a lateral velocity estimated using the physical model, and a longitudinal velocity estimated using the wheel velocity.

11. The method of claim 10, wherein the six degrees of freedom includes a longitudinal acceleration, a lateral acceleration, a vertical acceleration, a pitch rate, a yaw rate, and a roll rate.

12. The method of claim 10, wherein the sensor includes an inertia sensor and a vehicle interior sensor.

13. The method of claim 12, wherein the inertia sensor includes:
an acceleration sensor configured to measure the longitudinal acceleration, the lateral acceleration, and the vertical acceleration, and
a gyro sensor configured to measure the pitch rate, the yaw rate, and the roll rate.

14. The method of claim 12, wherein the vehicle interior sensor includes:
a steering angle sensor configured to measure a steering angle, and
a wheel velocity sensor configured to measure a wheel velocity.

15. The method of claim 10, further comprising:
estimating, by the processor, a vehicle lateral velocity and a lateral slip angle by combining a kinematic model based lateral velocity and a physical model based lateral velocity,
estimating, by the processor, a vehicle longitudinal velocity by combining the kinematic model based longitudinal velocity and the wheel velocity based longitudinal velocity,
assigning, by the processor, weights to the kinematic model based lateral velocity and the physical model based lateral velocity depending on a driving situation, and
assigning, by the processor, weights to a kinematic model based lateral velocity and a physical model based lateral velocity depending on the driving situation.

16. The method of claim 15, wherein the driving situation is classified into a non-linear tire friction interval and a linear tire friction interval.

17. A non-transitory computer readable medium containing program instructions executed by a processor, the computer readable medium comprising:
program instructions that control a sensor to measure six degrees of freedom and vehicle information;
program instructions that estimate kinematic model based longitudinal velocity and lateral velocity, a physical model based lateral velocity, and a wheel velocity based longitudinal velocity using the six degrees of freedom and the vehicle information; and
program instructions that estimate the vehicle velocity by combining a longitudinal velocity and lateral velocity estimated by the kinematic model, a lateral velocity estimated using the physical model, and a longitudinal velocity estimated using the wheel velocity.

18. The non-transitory computer readable medium of claim 17, wherein the six degrees of freedom includes a longitudinal acceleration, a lateral acceleration, a vertical acceleration, a pitch rate, a yaw rate, and a roll rate.

19. The non-transitory computer readable medium of claim 17, further comprising:
program instructions that estimate a vehicle lateral velocity and a lateral slip angle by combining a kinematic model based lateral velocity and a physical model based lateral velocity,
program instructions that estimate a vehicle longitudinal velocity by combining the kinematic model based longitudinal velocity and the wheel velocity based longitudinal velocity,
program instructions that assign weights to the kinematic model based lateral velocity and the physical model based lateral velocity depending on a driving situation, and
program instructions that assign weights to a kinematic model based lateral velocity and a physical model based lateral velocity depending on the driving situation.

20. The non-transitory computer readable medium of claim 19, wherein the driving situation is classified into a non-linear tire friction interval and a linear tire friction interval.
